(19) United States
(12) Patent Application Publication
(10) Pub. No.: US 2015/0163263 A1
(43) Pub. Date: Jun. 11, 2015

(54) SYSTEM FOR PROVIDING INTERACTION BETWEEN AN INTERNET OR BROADCAST AUTOMATION SYSTEM AND A SYSTEM OR PLATFORM FOR GATHERING WEB-BASED AUDIENCE INTERACTION WITH PROGRAMMING INCLUDING SECURE WEIGHTED OPEN SELECTION ITERATIVE MONITORING

(71) Applicants: Daniel Anstandig, Lakewood, OH (US); Brian Seeders, Cleveland, OH (US); Craig Helmut Bowman, Durand, MI (US)

(72) Inventors: Daniel Anstandig, Lakewood, OH (US); Brian Seeders, Cleveland, OH (US); Craig Helmut Bowman, Durand, MI (US)

(73) Assignee: FUTURI MEDIA, LLC, Cleveland, OH (US)

(21) Appl. No.: 14/627,907

(22) Filed: Feb. 20, 2015

Related U.S. Application Data
(63) Continuation-in-part of application No. 13/409,764, filed on Mar. 1, 2012.
(60) Provisional application No. 61/575,075, filed on Aug. 15, 2011.

(51) Int. Cl. H04L 29/06

(52) U.S. Cl. CPC H04L 65/403

(57) ABSTRACT

A platform comprising hardware and software is provided which securely links a broadcast station operating system or playback system via the internet to an external data source, such as a separate audience participation system for providing audience interaction with broadcast programming, and specifically radio programming to allow the automation system of the broadcast system operating system to play externally chosen, such as by audience participation, selections automatically and in real time. In a further embodiment, the platform monitors the location and content of a file which receives a selection, along with the process by which the selection is determined.

### CROSS REFERENCE

This Application claims the benefit of priority under 35 U.S.C. §119 of U.S. Provisional Application Ser. No. 61/575,075, filed on Aug. 15, 2011, herein fully incorporated by reference, and is a Continuation in Part application of U.S. patent application Ser. No. 13/409,764 filed on Mar. 1, 2012.

### FIELD OF THE INVENTION

The present invention relates to a platform which is a hardware and software system which links, for example via the internet, a broadcast automation system to an external data source, such as a separate audience participation system for providing audience interaction with a content provider of broadcast or internet programming, and specifically audio or video programming. Further this system works with existing broadcast or content automation systems and existing audience participation systems to influence the selection of broadcast content with the option of providing real-time selection of broadcast content or to provide content to be scheduled at a later time. The invention interfaces directly with a broadcast or internet station's studio operating system (including a music scheduler, a file system and an automation system), to manipulate the on-air content schedule and deliver audio files for chosen selections for on-air play based on a surrogate or placeholder placed in a given file location in a playlist generated by the broadcast station's selection scheduling software.

In a further embodiment, the system allows the manipulation of the criteria by which the audience participation is structured or “monitored”, and the ultimate selection is determined, including the ability to tailor the criteria for the selection process as to the audience complexion, demographic, geolocation and participation value, as well as the playlist considerations, such as flow of music and provider identity and security measures to maximize both the data security of the internal automation system of the provider and the flow of information via the social media to the audience members.

The present invention thus allows an “open selection session” which differs from the prior voting session by allowing the audience to vote on a population of choices which has been defined according to the provider provided characteristics, for example, top forty picks, or 1980's boy band selections. The audience participation system “monitors” a playlist including “dynamic content”, meaning a playlist having selections which change over time and which are generated by the selection (e.g. music or video) generation software or a provider automation playlist selection system or manually by the program director of the provider. “Monitor” is secure weighted open selection iterative monitoring and means that the audience participation system initiates the creation of a voting, participation or selection session, scrutinizes and authenticates the votes, applies criteria to filter and weigh the votes, and uses these to determine a selection.

The step of monitoring includes maintaining a schedule of the up-coming and past played selections, generating alerts for users or the audience participation session which 1) alerts (on air, over the Internet, by mobile, or by social media) an open audience (e.g. the listenership or viewership) to an up-coming opportunity to participate in the selection process or to a specific upcoming selection such as an artist or song; and 2) applies a criteria to the votes generated by the participation session to filter and weigh the votes according to defined perimeters. These might include filtering out non-human like voting behavior, votes from an audience member who demonstrates through voting behavior that they are outside the average behavior of the rest of the audience or who wish to overload the votes for personal gain, and weighing votes according to target demographic and geographic considerations. Considerations can include previous voting behavior, ip addresses or mobile coordinates, and more generally the credibility and suitability of the actual vote. In the “open selection” process in which a high density, meaning the number of adjacent or sequential individual selection participation opportunities, of selection opportunities exist for audience participation (for example, in which the audience may select adjacent selections in a time period, or some portion or even all of the selections in a given time period), it becomes increasingly important for the audience participation system to take a more active role in the determination of the next selection in querying the audience, filtering, weighing and evaluating the selection choices.

There is an art to creating a playlist, or choice and order of selections, in order to achieve a provider identity based on a particular flow of music or visual experience, achieve certain ratings or audience retention metrics, and including the ability of the provider to interject its own criteria. In the present invention, this happens in the context of an open audience population (that is, the participants are not necessarily pre-screened, but self-select in response to an open invitation to participate which is generated by the audience participation system of the present invention). The audience participation system thus balances the objectives of maximizing the participation of a selected portion of the invited audience, maintaining a secure two way conduit or relay for the participation, and providing a desired or defined playlist experience. It is imperative to avoid the creation of a playlist which produces a dissonant cacophony of sounds or visual experience and desirable to create a playlist which meets a defined aesthetic.

In a broader application, the audience participation system enables a provider to maintain a defined population of selections (e.g. from 10 to 1,000, or more preferably from 100 to 500 selections) and to allow the audience to participate in real-time and at intervals in the determination of selections to be played at scheduled times or simultaneously. For example, a set of 500 selections are provided, and the audience can vote on selections to be played at the top of the hour, or at the end of a broadcast session, and the audience participation system permits this to occur in the context of an automated system that maintains security for the provider and mimics the vibrancy of a human DJ.

The invention relates to a platform through which listeners or viewers can participate in the selection of an on-air experience from a provider that will play on the content provider or Internet stream in real-time and also through which the content provider can securely communicate with the audience.

### BACKGROUND OF THE INVENTION

The nature of the broadcast radio competitive landscape has changed significantly over the past decade. New various electronic devices, such as mp3 players, have provided a greater number of options for music and spoken word consumers to enjoy audio content. Whereas 50 years ago, over the airwaves radio was the primary source of audio entertainment and a “radio” was the only means of listening to radio broadcasts, a multitude of receiver options are presently available to audio listeners. Moreover, CD and MP3 players, as well as the Internet, have given listeners the ability to choose audio content for themselves, leaving broadcast radio working hard to attract and maintain its audience.

In the past, broadcast radio has instituted methods to allow an audience to participate in content selection, including call-lines and listener surveys. These have helped some radio stations develop or maintain listener loyalty and to maintain market share. However, they have always required a “curator,” such as a Disc Jockey or Program Director to adjust the radio station's programming using the information collected from the surveys and “phone call-ins.”

More recently, broadcast systems have adopted automation systems, such as “SS32”, “Maestro”, “AudioVault”, “Nexgen”, “WideOrbit”, or “Station Playlist” which play selections by utilizing on-air schedules including music, spoken word, and commercials that have been generated by content scheduling software and subsequently exported by a file system to the automation system. However, these broadcast automation systems have the problem that the playlists cannot be automatically changed to provide for audience participation and require the intervention of a human operator who has to over-ride the automation system in order to make changes in the scheduling or playlist. Thus, it has been a problem that certain broadcast automation systems do not allow for the option of automatically using an external data source, such as an audience participation program, to allow the audience to participate in the choice of broadcast content. Because of dangers inherent to or at least rightfully perceived to be inherent to an open Internet system, content providers were reluctant or restricted by very prudent security concerns from embracing web-based input for audience participation. The present invention enables the transfer of authenticated files within a validated and secure environment which can accommodate the security concerns of both the content provider and the audience. This platform only moves a file from and into a validated secure environment, and serves as an intermediate or relay which provides an extra level of security for both content providers and the audience. It also makes it possible to communicate securely and in real time between a web-based environment and a content provider's closed network.

This invention provides a unique transparency between a live audience and a content provider or providers and creates a live interaction with an audience which enables the individuals of that audience to vote on content, and participate securely in the selection of content. The widget of the present invention relays the live wishes of the audience to the content provider where both can receive information such as guidance as what to play next or alerts as to what is coming up.

The present invention provides a platform, i.e. both hardware and a software system in which the audience's votes and participation can automatically (i.e., without the need for a person to participate) manipulate an audio or video provider schedule or programming schedule by interfacing with the radio station's studio operating system including the automation system and/or programming scheduling software. In particular, this system provides a file, which is generated as a choice of a given number of selections upon which audience members were permitted to vote. A chosen selection is then routed directly by means of a placeholder or surrogate file by the invention into the radio station's playlist (which resides in the radio station's music scheduling software or radio automation system) as the next play. Selection is generally dictated by the audience participation system, which can use a variety of criteria for the selection choice. The selection can be chosen from a number of choices by meeting a criteria, such as the most number of positive votes, the least number of negative votes, or by another defined criteria, such as a geographic or demographic characteristic or even individualized preferences. The audience participation system can include means as part of the voting process to prompt members of the audience to participate in a vote by various means including broadcast alerts, texts, IM or e-mail alerts or other social media. In this embodiment, the voting session enables a selection between a limited number of selections, all of which are suitable for play at any position in a playlist.

In the further embodiment of the present invention, the audience participation system can enable an open selection process, meaning that the invited audience can participate in a manner that facilitates a far wider number of possible selections and a wider range of possible times to play the ultimate selection which results in a virtually limitless possibility of combinations of sequenced selections. As the structure of the pre-defined playlist is eliminated and the number of possible selections is expanded, the audience participation system of the present invention has to manage a more active role in the process of monitoring the voting session, including the verification and valuation of the votes, and rule by which the selections are weighted to maintain the programming goals of the content provider, including criteria such as geographic, demographic, voter history, and security concerns.

### SUMMARY OF THE INVENTION

The present invention provides for a software link which securely uses the Internet to communicate between a broadcast or content provider automation system and an external data source (i.e. web-based). The external data source is advantageously an audience participation or interaction system for broadcast programming, which gathers audience input or characteristics, including, for example, votes via an interactive interface accessible through the communication network, which includes various electronic communication methods, such as the internet, telephone and cable, and mobile devices, such as cellular, tablet/e-pads, and PDAs. The present invention uses a placeholder or surrogate file to stand in the place of the selection which is provided by the audience participation system and which is ultimately generated by the audience participation system and in response supplied from the broadcast automation system as an audio file to the broadcast automation system for on-air play.

Thus, the software system of the present invention system includes software that permits the radio station' studio automation system to interact via an external communication means such as the web, with a separate server which hosts the process of selection determination. Specifically, the software monitors a definable location for playlist information, such as new log exports, which are generated by the radio station automation system or a music scheduling program. An example of an acceptable log export is a text-based file containing data that represents the on-air schedule for a broadcast station for a given period. The file is row and comma based where each row in the file (separated by a line-feed character, carriage return character, or combination of both) represents one entry in the schedule. Each row is separated into multiple fields. These fields contain information such as: Media Type, Category, Cart Number, Scheduled Date/Time. A list of multiple selections are replaced by a placeholder selection that is used as a surrogate number/filename for the winning selection. The separate server advantageously conducts the audience interface and stores the resulting data, which are published to a web widget of the radio or content provider station to conduct the voting session. The software receives data for the broadcast station, which it uses internally, manipulates it as necessary, and forwards it to the separate server via a secure web-based API. The software queries the web-based API which provides XML data to convey the current winning selection from the audience participation system using HTTP GET via TCP-IP which are sent back from the separate server to the software system. The software system then copies the contents of the digital audio file of the winning selection to a new file (“placeholder” file) using a file location, which causes the radio station automation system to import the digital audio file. This results in the selection being played on-air when the placeholder file reaches the on-air position of the automation system. The system is not limited to the use of log exports to manage playlist information, and can encompass other methods of transferring information.

In a separate aspect of the invention which is termed herein an “open selection event”, a series of selections can be played. In this aspect of the invention, the audience ranks selections chosen from a defined set. Again, the radio station automation system encounters a command from the separate server, which begins the radio station/software/separate server interaction session. The software queries the server web-based API which provides XML data containing information about which selection or song in the selection voting currently has the most votes. This selection will be the next play when a placeholder file is encountered in the on-air schedule, and after play, the software will notify the separate server by a web-based APL so that the separate server resets the votes on that selection and moves it into last place. The next-most voted selection then becomes the top selection, which the software will copy into the next placeholder file. This process repeats until the radio station automation system encounters a command from the separate server to end the song or selection replacement session in the on-air schedule. Then a web-based notification is sent to the separate server to de-activate the song or selection replacement session.

In a further embodiment the open selection event does not choose the selection for play from a selected pool of acceptable selections to be placed into a given spot, but rather allows the audience to vote on a population of selections which are monitored by the audience participation system to provide a selection which has been selected according to a criteria which includes filtered and/or weighted audience votes, along with playlist criteria to preserve the experiential goals of the content provider.

### BRIEF DESCRIPTION OF THE DRAWINGS

FIG. 1 is diagram of the present invention;

FIG. 2(a) is a representation of a Selector selection log which is generated by a broadcast automation system;

FIG. 2(b) is a representation of a Selector selection log after it has been parsed by an audience participation system;

FIG. 3 is a representation of a format of XML generated by the broadcast automation system which is received and re-formatted by the software system of the present invention and which are sent to the audience participation system by means of HTTP POST via a web-based API;

FIG. 4 is a screen shot of a list of songs that have been played and will be played for a radio station in accordance with the invention;

FIG. 5 is a screen shot of the code separation information to determine selection play characteristics;

FIG. 6 is a screen shot of the active separations which determines the selection play characteristics;

FIGS. 7a and 7b together are a screen shot of the applied criteria to determine the selection; and

FIG. 8 is a spread sheet that illustrates the application of the monitoring and determination of selection processes of the present invention.

### DETAILED DESCRIPTION OF THE INVENTION

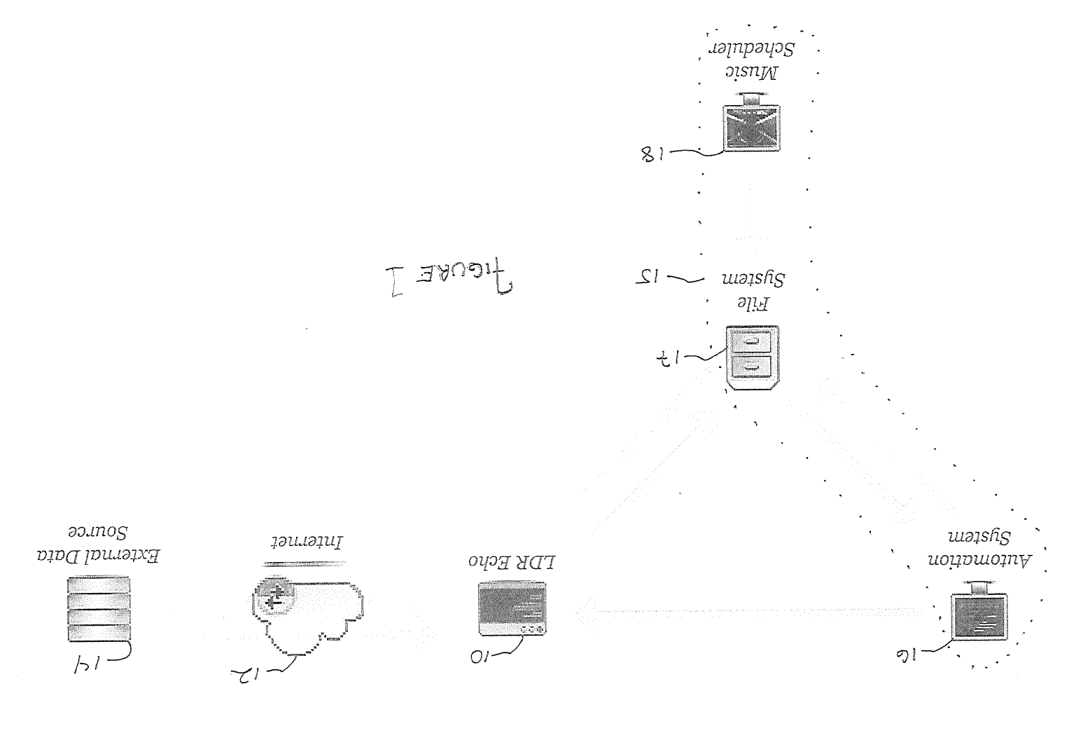

FIG. 1 shows a schematic view of the software system in accordance with the present invention in the context of the interaction between the external data source and specifically, the audience participation system, and the content provider or broadcast automation system. While the invention is described with respect to a separate and external audience participation system (i.e. which is implemented and managed apart from the broadcast station), it should be understood that the data source can be internal to the broadcast station and operate as part of the automation system and where the link of the present invention is used as a platform or mechanism to import either files external to the initial playlist, file system, and/or automation system or to determine content to be placed into a file or location in existence in the automation system playlist or selection sequence.

The software system of the present invention uses a surrogate or placeholder which is an entry in a log export file (and thus an on-air schedule) that will later be replaced by another selection. The log export file is a text-based file which uses row and comma format for data that represents the on-air schedule for a broadcast station for a given period, such as a broadcast day. The schedule is generally created in a music scheduler first and then exported to a broadcast automation system. Each placeholder has a category and/or number that corresponds to a file on the file system from which the chosen selection can be played by the broadcast automation system. The invention subsequently copies the selection's file contents into this placeholder file to cause that selection to be played. In the log export file, each row in the file is separated by a line-feed character, carriage return character, or combination of both and represents one entry in the schedule. Each row is separated into multiple fields, which are separated by commas. These fields contain information such as Media Type, Category, Cart Number, and Scheduled Date/Time.

The software system, shown generally at 10, further interacts such as by way of the internet 12, with an external data source, which is specifically an audience participation system shown generally at 14. The audience participation system allows the audience to indirectly and securely interact with the broadcast station operating system 15 which includes an automation system 16, a file system 17 and a music scheduler 18. One type of interaction that can be used to gather data to modify an on-air schedule is a voting session in which a group of songs are provided by the broadcast station, placed in the on-air schedule, and read by the audience participation system to enable it to create a voting session (for example a vote which lasts a specified period of time on the choice of one of three given selections to determine a single winner to be placed into a single location in a playlist stream and without disturbing the stream play) which can be viewed and voted upon by the audience using a web-based application. The voting session is conducted by the audience participation system 14 for a given period, and when it ends, the votes are tallied and the winning selection can be supplied by the software system 10 using the internet 12 to the broadcast station operating system 15 to be played on the air.

Another type of audience interaction is an open selection event which gives the audience the ability to vote upon a larger number of selections and to rank the selections. The selections are supplied to the broadcast automation system in an order, such as by popularity, and played on-air according to that order. After a selection has been played, it is moved to the end of the list and the next selection is played in the next available placeholder spot. This type of interaction can continue for a selected amount of time, i.e. while the interaction between the broadcast station automation system and the audience participation system remains linked or “open” by the software system of the present invention so that a number of selections are supplied during an open selection event for separate voting sessions or events.

The audience participation system uses a software program, to gather the “Now Playing” or “Currently Playing” selection data which includes the title, artist and other information representing the selection that is currently playing on-air on the broadcast station. The broadcast automation system generally sends the “now Playing” data in a single format, but the software of the present invention has the ability to forward this information in a variety of different formats to multiple sources using a variety of protocols, such as XML over TCP/IP. The audience participation system uses various commands or entries into the on-air-schedule to determine when certain events will happen, including the start of a given voting session which exists in a 0-second audio file, vote option start and end commands that combine to denote a list of selections that are available in a voting session, and for open selection event, the begin selection replacement and end selection replacement commands that begin and end the open selection event.

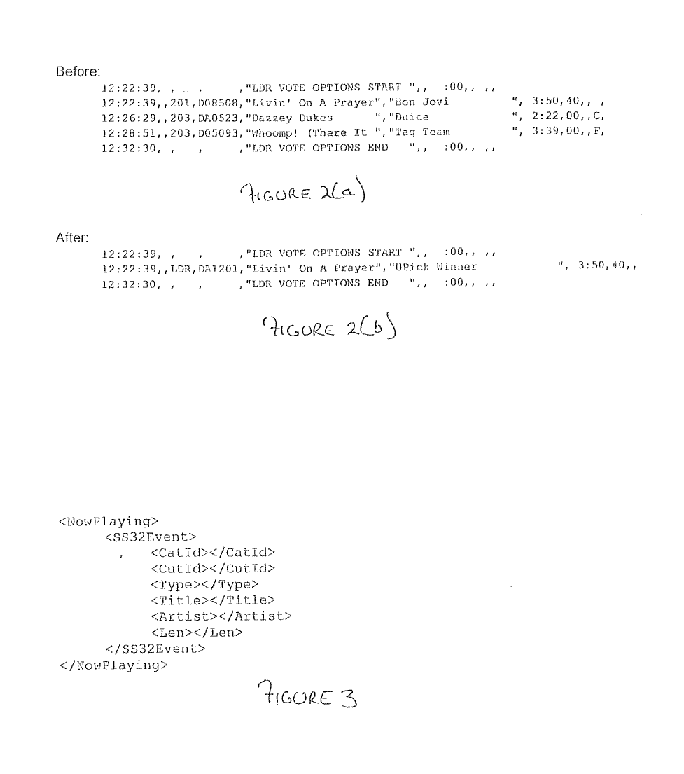

The linking software uses a placeholder or surrogate in a log export file to allow the external data source to communicate with the station broadcast automation system. The placeholder is an entry in the log export file (and thus in the on-air schedule) that will later be replaced by a selection. This event is illustrated in FIGS. 2(a) and 2(b). Each placeholder has a category and/or number that corresponds to a file on the file system from which the chosen selection can be played by the automation system. The linking software of the present invention copies an audio file content from the broadcast station file system into the placeholder file to make that audio file play.

The audience can use the audience interaction user interface or “widget” to view a list of selections made available by the broadcaster and can vote to play those selections at a later point or “on-the-air” as directed by the broadcaster. The broadcaster is given the option for incorporating audience interaction through a playlist management system which includes controls for the playlist module, controls to activate various settings related to feeding the radio station studio operating system, a screen to add a selection to the playlist, to start a voting session by adding a “pick next” voting session, to view live voting session results by managing and viewing “pick next” voting sessions, and to generate voting result reports.

The software linking system 10 of the present invention includes four major components, each responsible for a separate process, that can be combined together to create the functionality required to enable the broadcast station automation system to play a selection chosen through a voting session or an open selection event.

The first component is a log parsing component which monitors a definable location (directory) for new log exports generated by the broadcast station selection scheduling program. That schedule is forwarded to the external data source, i.e. the audience participation system 10, and modified such that the multiple selections which will be included in a voting session are replaced with a place holder which will later be used as a surrogate number/filename for the winning selection. The voting sessions for each day are stored in a database on the audience participation server and are published to the station's web widget for public voting. FIG. 2(a) and (b) illustrates an example of a voting session before and after the log parsing taken from a Selector music log intended for an automation manufactured by Scott Studios/dMark/Google/Wide Orbit as defined by these automation manufacturers. Other automation system manufacturer's music import format is likewise supported by the present invention.

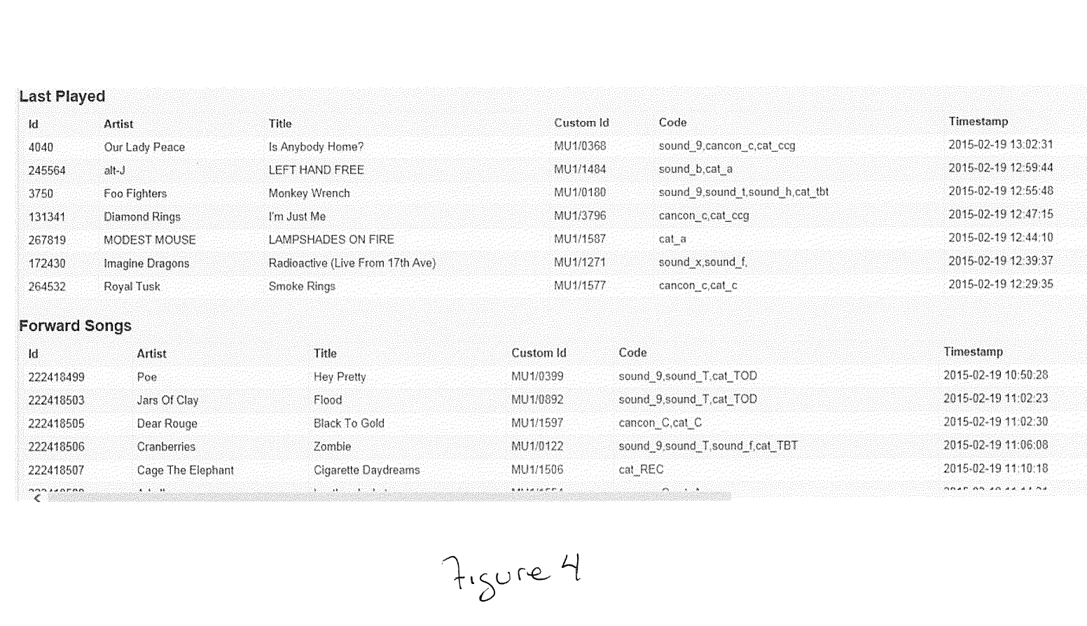

As a second component, the linking system receives Now Playing data from the broadcast station automation system 16, uses this information internally, and forwards this information to the audience participation system via a web-based API. The information is formatted, for example in XML, and transferred via a TCP/IP connection as a stream of bytes. The format for XML coming from the broadcast station automation system is illustrated in FIG. 3. The software linking system re-formats this now playing data, and sends it to the audience participation system via HTTP POST via a web-based API. The data is sent along with authorization credentials (username and password) for security. The HTTP POST parameters used by this API are:

station Id
A string of characters that identifies the station to the audience participation system
auth_username
A string of characters representing the username used for authentication
auth_password
A string of characters representing the password user for authentication
selectionID
A string of characters that contains the category and cart number of the selection from the broadcast station automation system. These two pieces of data combined identify the selection in the automation system. These two pieces of information are combined into one string and separated by a forward-slash (“/”). The category comes first, followed by the cart number.

### Example: S01/0865

artistName
A string of characters identifying the artist of the selection that is playing
selectionName
A string of characters identifying the title of the selection that is playing
timestamp
A string of characters representing the date and time in the automation system at the time at which the selection was played.
The string is in the format of YYYY-MM-DD: HH:II:SS
YYYY is year in 4-digit format, “2011
MM is month in 2-digit format, “01” or “12”
DD is day in 2-digit format, “01” or “31”
HH is hour in 24-hour format, “01”-“23”
II is minute in 2-digit format, “01”-“59”
SS is second in 2-digit format: “01”-“59”
length
An integer representing the number of seconds for which the selection will be playing

The third component implements the ability of the software link 10 of the present invention to use a voting session. In this component, using HTTP GET via TCP-IP, the link queries the audience participation system web-based API which provides XML data to convey the current “winner” of the voting session. Details about the HTTP request and the XML are then sent back from audience participation system. Once the winner has been received by the software link, the digital file of the winning selection is copied to a new file (“placeholder” file) using a specific filename and saved to a specific location, which will cause the broadcast station automation system to import it, causing the winning selection to be played when the placeholder (from Component 1,) reaches the on-air position of the automation system.

As an example:

\\automation_machine\share\audio_directory\winning_song.wav would be copied to:

\\automation_machine\share\audio_directory\import_location\placeholder_song.wav

The fourth component implements the open selection event feature of the present invention. To begin an open selection event, the station broadcast automation system encounters an audience participation system command in the on-air schedule called “Begin Song Replacement”. This command is sent to the audience participation system, via its web-based API, and it will begin publishing open selection event data to its API. Using HTTP GET via TCP-IP, the software link system 10 queries the audience participation 14 web-based API which provides XML data containing information about which selection in open selection event currently has the most votes. This is the next selection that should play on the air during the open selection event. When the most-voted selection changes, the software system 10 of the present invention will copy the contents of the digital audio file which contains that selection into the next placeholder file scheduled to play in the automation system 16. It should be understood that the system could also supply a video file or an audio and video file for broadcast media other than radio and also that song is used herein as an example of a type of selection (along with spoken word or video selections, for example) that could be supplied. When the automation system encounters the placeholder file in the on-air schedule, the current most-voted selection plays on the air. When it plays, the software link sends a notification to the audience participation system 14 via the web-based API, and the audience participation system 14 resets the votes on this selection, putting it in last place. The next most-voted selection becomes the top selection, which the software link will begin copying into the next placeholder file. This process repeats until the automation system encounters the audience command “End Selection Replacement” in the on-air schedule. When the automation system 14 encounters the audience participation command “End Selection Replacement” in the on-air schedule, a notification is sent to the audience participation system 14 via the web-based API, and the audience participation system 14 de-activates the open selection event.

The following section outlines, from start to finish, the process by which each interaction, and subsequent schedule modification, is executed. Numbers in parentheses refer to diagram shown in FIG. 1 which shows flow of data through the system.

### Voting Sessions

Broadcast Station personnel creates an on-air schedule for a given day using music scheduling software. Commands for the audience participation system are contained within this schedule.

The schedule is exported to a text file on the file system 17.

The software link system 10 of the present invention, while monitoring for new log export files, discovers the new export file and reads it from the file system 17.

The software link system sends the log export file to the audience participation system 14 API via the HTTP interface. The connection is left open so that the audience participation system 14 server can send information back.

The audience participation system 14 server reads the audience participation system 14 commands from the export file, and replaces the necessary commands with placeholder selections, which the software link will later change.

The audience participation system 14 server sends the updated export file (with new placeholders) back to the software link system 10 application through the still-open HTTP connection, then closes the connection.

The software link system 10 application sends the new export file back to the file system 17 so that the automation system 16 can export it.

The broadcast automation system 16, while monitoring for new export files, discovers the new export file and reads it from the file system 17, importing the schedule contained within.

The broadcast automation system 16 plays music and other schedule entries as normal, until it reaches the audience participation system 14 command entry UPickStart, which signifies the beginning of a voting session.

The UPickStart command “plays” in the automation system 16, as if it were music, for zero seconds.

The Now Playing event data for the UPickStart command is sent to the broadcast station automation system 16 application.

The broadcast automation system 16 application sends this event data to the software link system 10 in XML format.

The software link system 10 forwards this information to the audience participation system 14 API via the HTTP interface.

The audience participation system 14 server activates the voting session associated with the UPickStart command and begins publishing the live results of the voting session to the API.

The software link system 10 application begins making periodic requests for up-to-date voting session information at a set interval to the audience participation system 14 API via the HTTP interface.

After each request for new information, if the winning selection (i.e., the selection with the most votes) has changed since the last request, or if this is the first request, the software link system 10 will send a command to the file system 17 to copy the digital audio file containing the winning selection into a new file corresponding to the placeholder entry in the on-air schedule. This file is in a special “inbox” directory, a directory from which the file will be read and refreshed by the broadcast station automation system 16, prior to playing on the air.

The broadcast station automation system 16, while monitoring the file system 17, discovers the new audio file for the placeholder entry and loads the data in the file, including metadata such as selection title and artist. The audio file is then queued to play when the automation system 16 encounters the placeholder on-air schedule entry.

When the broadcast station automation system 16 encounters the placeholder on-air schedule entry for the currently active voting session, the most recently queued (from Step 17) audio file for this entry is played.

The automation system 16 sends this Now Playing event to an automation system 16.

The automation system 16 sends this Now Playing event, in XML format, to the software link system 10 application.

The software link system 10 application recognizes this now playing event as the winning selection for the voting session, and stops making audience participation API requests for voting session information.

The software link system 10 application sends the winning song information to the audience participation system 14 API via the HTTP interface.

The audience participation system 14 server recognizes that the winning selection has played, and de-activates the voting session.

Steps 9-23 repeat for each voting session in each on-air schedule.

After the station has scheduled its daily music log and it has been processed by component 1 of the software link system, a specific file is played by the stations automation system 16 and is sent (via Component 2) to the audience participation system 14 server triggering a voting session on the stations website. Once this command is received the selections which were scheduled for voting are placed in a custom widget which is embedded into the broadcast stations website. Listeners can vote on the selection they want to play next and those votes are tabulated by audience participation system. The software link system 10 checks into the audience participation system 14 server for the winning selection and as each new winner is determined the winning selection is processed by component 3. Once the winning selection is determined to have played (via component 2) the voting session on the website is closed.

### Open Selection Event

Radio Station personnel creates an on-air schedule for a given day using music scheduling software of the music scheduler 18. Audience participation system 14 commands are contained within this schedule.

The schedule is exported to a text file on the file system 17.

The software link system 10, while monitoring for new log export files, discovers the new export file and reads it from the file system 17.

The software link system 10 sends the log export file to an audience participation system 14 API via the HTTP interface. The connection is left open so that the audience participation system 14 server can send information back.

The audience participation system 14 server reads the audience participation system 14 commands from the export file, and replaces the necessary commands with placeholder songs, which the software link will later change.

The audience participation system 14 server sends the updated export file (with new placeholders) back to the software link system 10 application through the still-open HTTP connection, then closes the connection.

The software application system 10 sends the new export file back to the file system 17 so that the broadcast station automation system 16 can export it.

The broadcast automation system 16, while monitoring for new export files, discovers the new export file and reads it from the file system 17, importing the schedule contained within.

The broadcast automation system 16 plays music and other schedule entries as normal, until it reaches the audience participation system 14 command entry Begin Song Replacement, which signifies the beginning of an open selection event.

The Begin Song Replacement command “plays” in the automation system 16, as if it were music, for zero seconds.

The Now Playing event data for the Begin Song Replacement command is sent to the broadcast station automation 16 application.

The broadcast station automation 16 application sends this event data to the software link system in XML format.

The software link system 10 forwards this information to the audience participation system 14 API via the HTTP interface.

The audience participation system 14 server activates an open selection event and begins publishing the live results of voting to the API.

The software system 10 application begins making periodic requests for up-to-date voting information at a set interval to the audience participation system 14 API via the HTTP interface.

After each request for new information, if the winning selection (e.g., the selection with the most votes or the selection with the least losing votes) has changed since the last request, or if this is the first request, the software link system 10 will send a command to the file system 17 to copy the digital audio file containing the winning selection into a new file corresponding to the placeholder entry in the on-air schedule. This file is in a special “inbox” directory, a directory from which the file will be read and refreshed by the automation system 16, prior to playing on the air.

The broadcast station automation system 16, while monitoring the file system, discovers the new audio file for the placeholder entry and loads the data in the file, including metadata such as song title and artist. The audio file is then queued to play when the automation system 16 encounters the placeholder on-air schedule entry.

When the broadcast station automation system 16 encounters the next placeholder on-air schedule entry, the most recently queued (from Step 17) audio file for this entry is played.

The broadcast automation system 16 sends this Now Playing event to the automation system 16.

The automation system sends this Now Playing event, in XML format, to the software link system 10 application.

The software link system 10 application sends the selection information to the audience participation system 14 API via the HTTP interface.

The audience participation system 16 server recognizes that the selection has played, and resets the votes for this selection, so that a new selection is published via the API.

Steps 9-22 repeat for each open selection event placeholder in each on-air schedule, until the End Song Replacement command on-air schedule entry is encountered.

The End Song Replacement command “plays” in the automation system 16, as if it were music, for zero seconds.

The Now Playing event data for the End Song Replacement command is sent to the automation system 16 application.

The automation system 16 application sends this event data to the software link system 10 in XML format (1)

The software link system 10 recognizes that an open selection event is now turned off, and stops making requests to the audience participation system 14 API for new selection information.

The software link system 10 forwards this information to the audience participation system 14 API via the HTTP interface (2).

The audience participation system 14 server de-activates the open selection event.

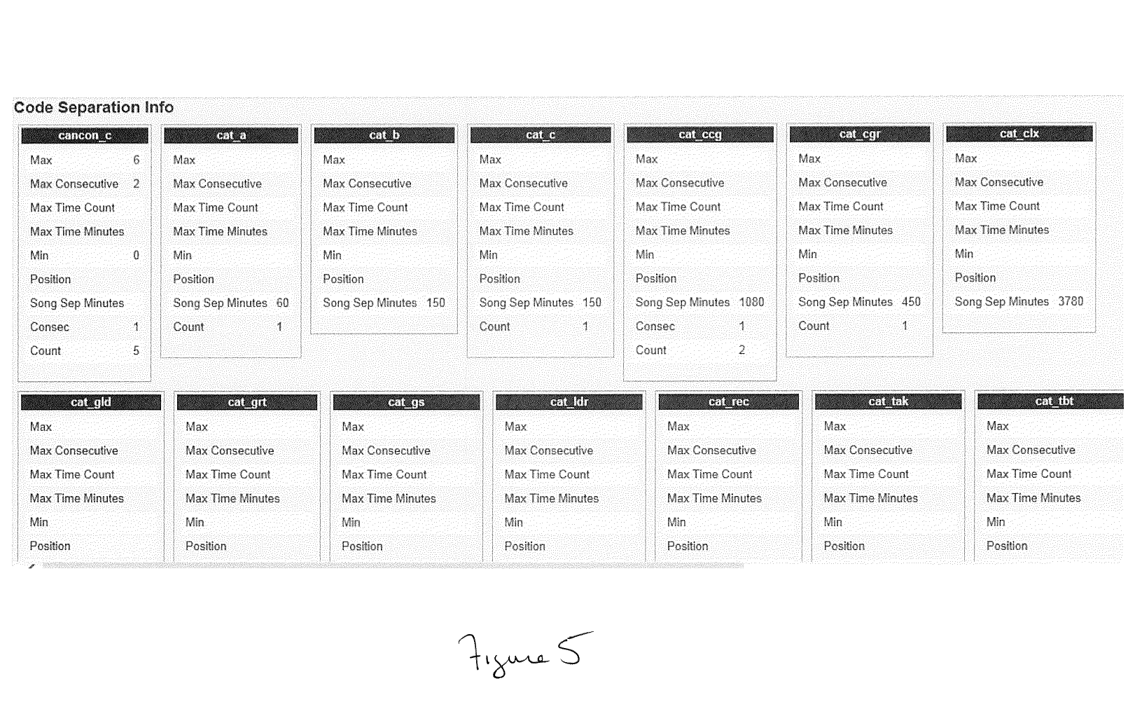

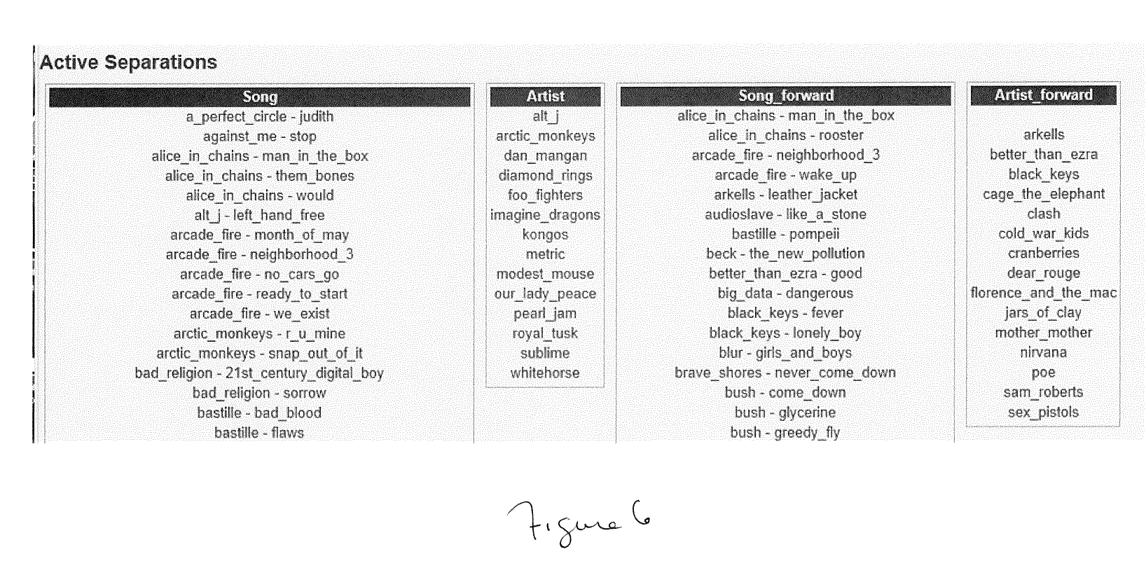

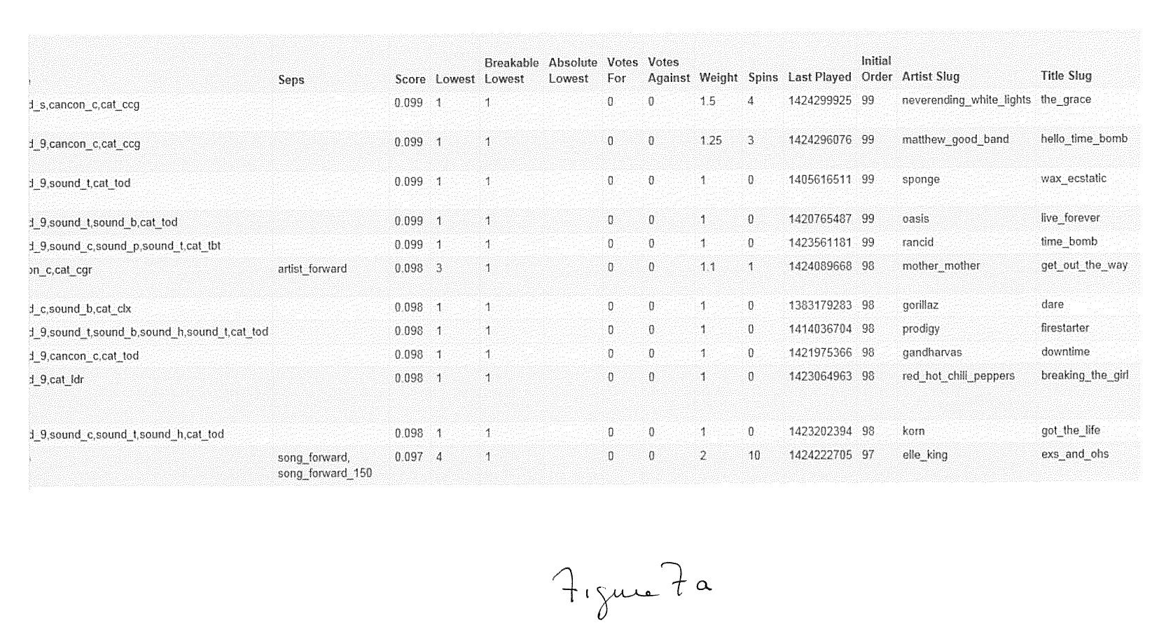

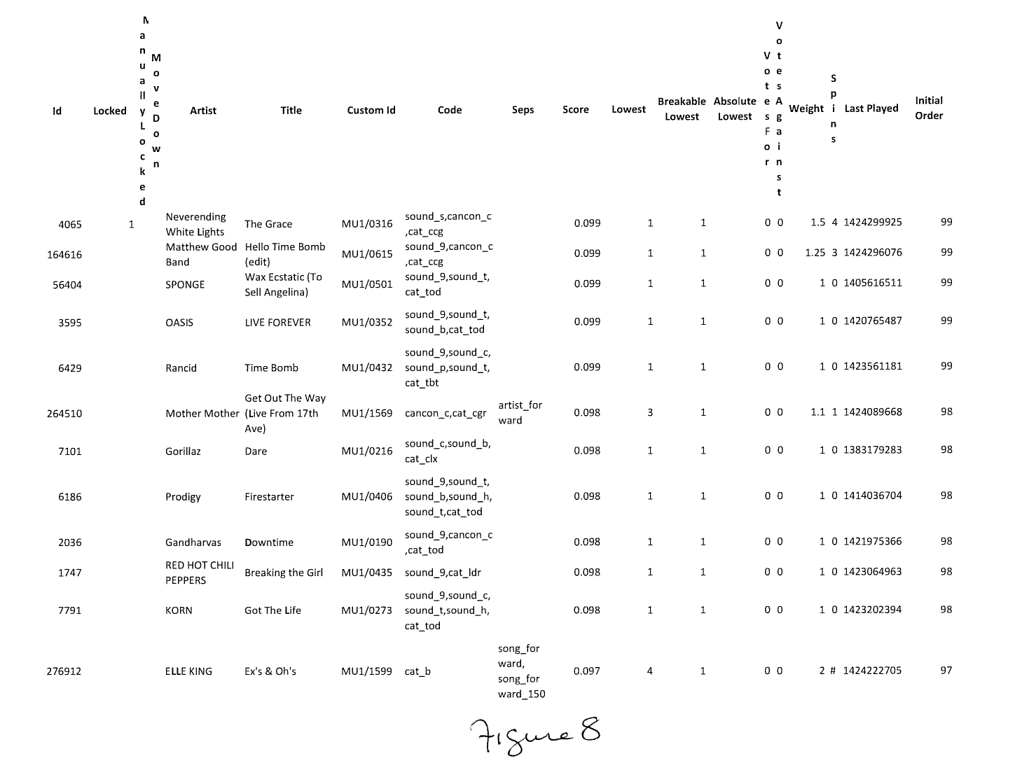

In a further embodiment, the present invention allows an “open selection session” which facilitates the manipulation of the criteria by which the audience participation is structured or “monitored”, and the ultimate selection is determined. This includes the ability to tailor the criteria for the selection process as to the audience make-up or complexion, demographic, geolocation and participation value, as well as the playlist considerations, such as flow of music and provider identity. It also provides security measures to maximize both the data security of the internal automation system of the provider and the flow of information via the social media to the audience members. FIGS. 4-8 illustrate the specific way in which the audience participation system “monitors” a playlist, and provides for file locations which include “dynamic content”. By this, it is meant that the invention enables a playlist having selection locations with content which can change from moment to moment and which are generated by the selection (e.g. music or video) generation software or a provider automation playlist selection system or manually by the program director of the provider. In this context, “monitor” means that the audience participation system initiates the creation of a voting, participation or selection session, scrutinizes and authenticates the votes, applies criteria to filter and weigh the votes, and uses these to determine a selection.

The step of monitoring includes 1) maintaining a schedule of and code for the up-coming and past played selections (title and artist) as shown in FIG. 4, 2) securely generating alerts for users or the audience participation session which alerts (on air, over the Internet, by mobile, or by social media) an open audience (e.g. the listenership or viewership) to an up-coming opportunity to participate in the selection process or to a specific upcoming selection such as an artist or song; and 3) applies a criteria to the votes generated by the participation session to filter and weigh the votes according to defined perimeters so as to define a selection to be placed in a given location in the schedule.

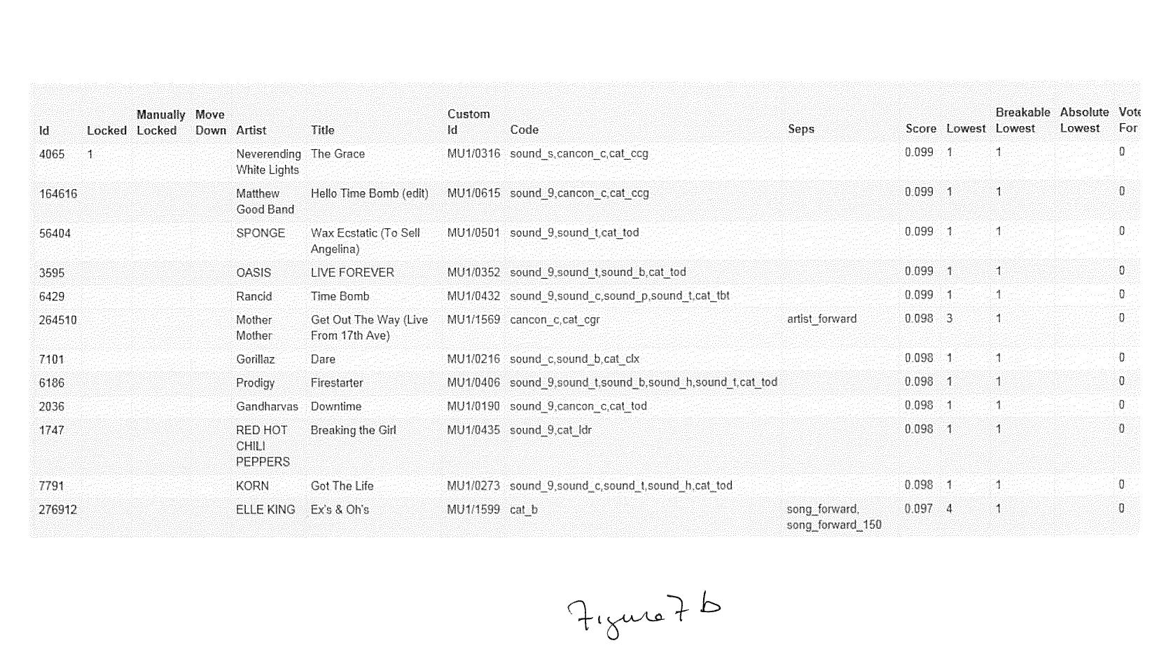

The monitoring activities or criteria specifically illustrated as applied in FIGS. 7a and 7b include vote weighting to filter out non-human like voting behavior or votes from an audience member who demonstrates through voting behavior that they are outside the average behavior of the rest of the audience or who wish to overload the votes for personal gain, and weighing votes according to target demographic and geographic considerations. Further considerations can include previous voting behavior, ip addresses or mobile coordinates, and more generally the credibility and suitability of the actual vote. These criteria or considerations are tabulated or computed to determine a score to help determine whether to play a selection and in what position.

It becomes increasingly important for the audience participation system to take an active role in monitoring the audience participation process, such as in the querying of the audience and evaluating the votes, and in filtering, weighing and evaluating the selection choices. In the “open selection” process there is a high density of locations for the substitution of audience prompted selections, meaning the number of adjacent or sequential individual selection participation opportunities, of selection opportunities exist for audience participation (for example, in which the audience may select adjacent selections in a time period, or some portion or even all of the selections in a given time period).

In the present invention, the creation of the playlist happens in the context of an open audience population. The participants are not necessarily pre-screened although they may have to sign on to participate, but more usually, they self-select in response to an open invitation to participate which is generated by the audience participation system of the present invention). The audience participation system thus balances the objectives of maximizing the participation of a selected portion of the invited audience, maintaining a secure two way conduit or relay for the participation, and providing a desired or defined playlist experience.

In a broader application, the audience participation system enables a provider to maintain a defined population of selections (e.g. from 10 to 1,000, or more preferably from 100 to 500 selections) and to allow the audience to participate in real-time and at intervals in the determination of selections to be played at scheduled times or simultaneously. For example, a set of 500 selections are provided, and the audience can vote on selections to be played at the top of the hour, or at the end of a broadcast session, and the audience participation system permits this to occur in the context of an link that maintains security for the provider and mimics the vibrancy of a human DJ.

While in accordance with the patent statutes the best mode and preferred embodiment have been set forth, the scope of the invention is not limited thereto, but rather by the scope of the attached claims.

What is claimed is:

1. A platform that comprises hardware and software to form a link which securely interfaces with the operating system of a content provider and the web-based source for the input of an audience comprising an open plurality of users, the operating system operating with a play schedule having a file with a selectable file content at a file location, and with an external data source which determines a selection based upon audience and selection criteria, wherein the software link determines the existence of the file and initiates and monitors a session of audience participation through the Internet to gather audience guidance as to the file content and securely determines the file content from moment to moment for real-time play.

2. A software system as set forth in claim 1 wherein the content provider is a broadcast station or digital content provider.

3. A software system as set forth in claim 1 wherein the audience criteria comprises information as to demographics, geolocation, and voting behavior.

4. A software system as set forth in claim 3 wherein the session of audience participation is a voting session or an open selection event.

5. A software link as set forth in claim 1 which is an open selection session in which there are at least two adjacent files having selectable file content.
